(19) United States
(12) Patent Application Publication
(10) Pub. No.: US 2003/0107856 A1
(43) Pub. Date: Jun. 12, 2003

(54) ESD protection circuit

(76) Inventors: Chien-Chang Huang, Hsin-Chu (TW); Jeng-Feng Lan, Hsin-Chu (TW)

Correspondence Address: Merchant & Gould p.c., p.o. Box 2903, Minneapolis,, MN, 55402-0903, US

(21) Appl. No.: 10/068,015

(22) Filed: Feb. 5, 2002

(30) Foreign Application Priority Data
Dec. 11, 2001 (TW) 90130703

(51) Int. Cl. H02H 9/00

(52) U.S. Cl. 361/56

(57) ABSTRACT

An ESD protection circuit protecting an internal circuit. The internal circuit is powered by a first and second power supply and has an input terminal receiving an input signal on a pad. A capacitor is connected between the input terminal of the internal circuit and the second power supply. The ESD protection circuit comprises a protection circuit connected between the pad and the first power supply, and establishing a conductive path from the pad to the first power supply when an ESD event occurs, and an inductance connected between the pad and the input terminal of the internal circuit, and cutting off a conductive path from the pad to the capacitor when the ESD event occurs.

### BACKGROUND OF THE INVENTION

1. Field of the Invention

The present invention relates to an ESD protection circuit, particularly to an ESD protection circuit protecting an internal circuit having a high capacitance at the input terminal.

2. Description of the Prior Art

FIG. 1 is a diagram showing a conventional ESD protection circuit protecting an internal circuit 11. The internal circuit 11 receives an input analog signal on a pad 12 and generates an output signal on the pad 13 through an output buffer 14. Additionally, there are four protection circuits 15a, 15b, 16 and 17, and a resistor R. All the active elements in FIG. 1 are powered by a positive VDD and negative VSS power supply.

A capacitor 18 is connected between the pad 12 or the input terminal of the internal circuit 11 and the VSS power supply to stabilize the voltage level at the input terminal.

The output buffer 14 comprises two transistors 141 and 142 having a conductivity opposite to each other. The protection circuits 15a and 15b comprise diodes 151a, 152a and 151b, 152b serially connected in the same direction respectively. The protection circuits 16 comprises two transistors 161 and 162 having a conductivity opposite to each other. The protection circuits 17 comprises transistors 171, inverter 172, resistor 173 and capacitor 174.

In the protection circuit 17, the transistor 171 has a source connected to the VDD power supply and a drain connected to VSS. The inverter 172 has an output connected to a gate of the transistor 171. The resistor 173 is connected between the VDD power supply and an input of the inverter 172. The capacitor 174 is connected between the input of the inverter 172 and VSS power supply.

The protection circuits 15a and 16 establish ESD paths from the pad 12 to VSS and VDD power supply, the protection circuit 15b establishes ESD paths from the pad 13 to VDD and VSS power supply, and the protection circuit 17 establishes an ESD path from VDD to VSS power supply. Thus, the internal circuit 11 is protected from ESD damages since the electrical charges generated on the pad 12, 13 or one of the VDD and VSS power supplies are discharged through one of the paths established by the protection circuits 15a, 15b, 16 and 17.

In the conventional ESD protection circuit, since the voltage pulse generated by electrical static charges on the pad 12 is equivalent to a signal with a extremely high frequency, the capacitor 18 induces a conductive path from the pad 12 and the VSS power supply when an ESD event occurs. As the electrical charges flow through the capacitor 18, the protection circuits 15a, 16 and 17 have no effect upon the protection of the internal circuit 11, and damage to the capacitor 18 occurs. Additionally, a large amount of static charges are accumulated on the capacitor 18 when the ESD event occurs. This prolongs the discharging period, which is also harmful to the internal circuit 11.

### SUMMARY OF THE INVENTION

Therefore, the object of the present invention is to provide an ESD protection circuit protecting an internal circuit having a high capacitance at the input terminal. The static charges are prevented from flowing through the capacitor when an ESD event occurs.

The present invention provides an ESD protection circuit protecting an internal circuit powered by a first and second power supply and having an input terminal receiving an input signal on a pad, wherein a capacitor is connected between the input terminal of the internal circuit and the second power supply. The ESD protection circuit comprises a protection circuit connected between the pad and the first power supply, and establishing a conductive path from the pad to the first power supply when an ESD event occurs, and an inductor connected between the pad and the input terminal of the internal circuit, and cutting off a conductive path from the pad to the capacitor when the ESD event occurs.

Thus, in the invention, an inductor is connected between the pad and the input terminal of the internal circuit. Since the inductor cuts off the conductive path from the pad to the capacitor when an voltage pulse with an extremely high frequency is induced on the pad by an ESD event, there is no longer an ESD current flow through the capacitor, which prevents damage to the capacitor and internal circuit.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a diagram showing a conventional ESD protection circuit.

FIG. 2 is a diagram showing an ESD protection circuit according to one embodiment of the invention.

FIGS. 3A and 3B are diagrams showing the inductor of an ESD protection circuit according to one embodiment of the invention.

### DETAILED DESCRIPTION OF THE INVENTION

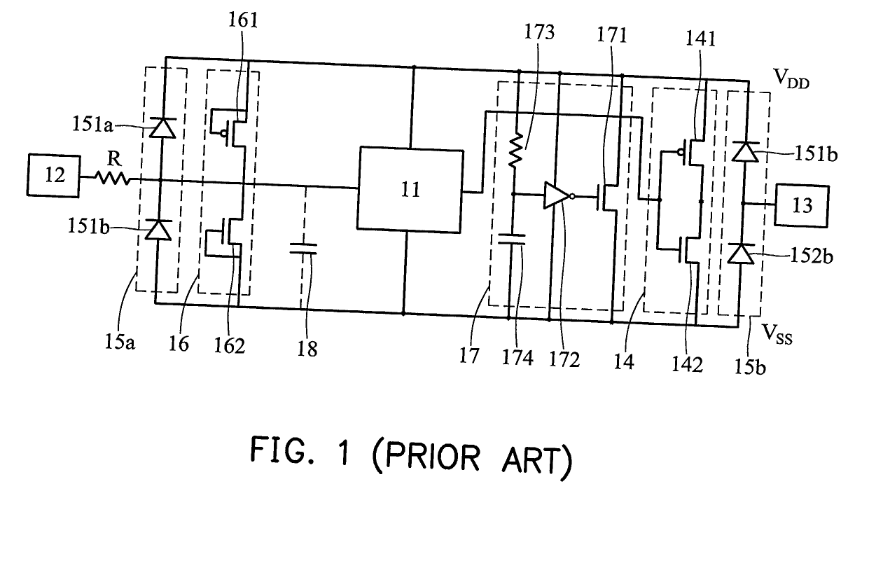

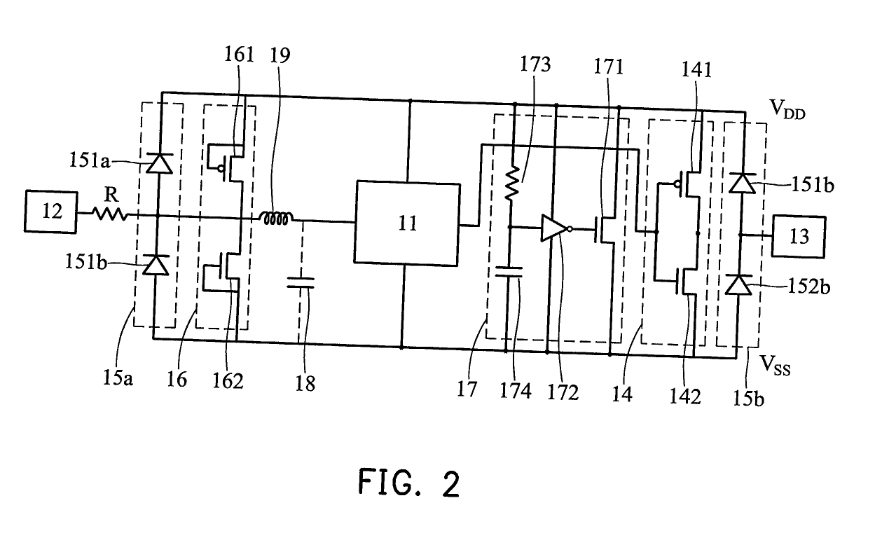

FIG. 2 is a diagram showing an ESD protection circuit according to one embodiment of the invention. The same elements in FIG. 1 and FIG. 2 refer to the same symbol for clarity.

The internal circuit 11 receives an input analog signal on a pad 12 and generates an output signal on the pad 13 through an output buffer 14. Additionally, there are four protection circuits 15a, 15b, 16 and 17, and a resistor R. All the active elements in FIG. 1 are powered by a positive VDD and negative VSS power supply.

A capacitor 18 is connected between the pad 12 or the input terminal of the internal circuit 11 and the VSS power supply to stabilize the voltage level at the input terminal.

The protection circuits 15a and 16 establish ESD paths from the pad 12 to VSS and VDD power supply, the protection circuit 15b establishes ESD paths from the pad 13 to VDD and VSS power supply, and the protection circuit 17 establishes an ESD path from VDD to VSS power supply. Thus, the internal circuit 11 is protected from ESD damages since the electrical charges generated on the pad 12, 13 or one of the VDD and VSS power supplies are discharged through one of the paths established by the protection circuits 15a, 15b, 16 and 17.

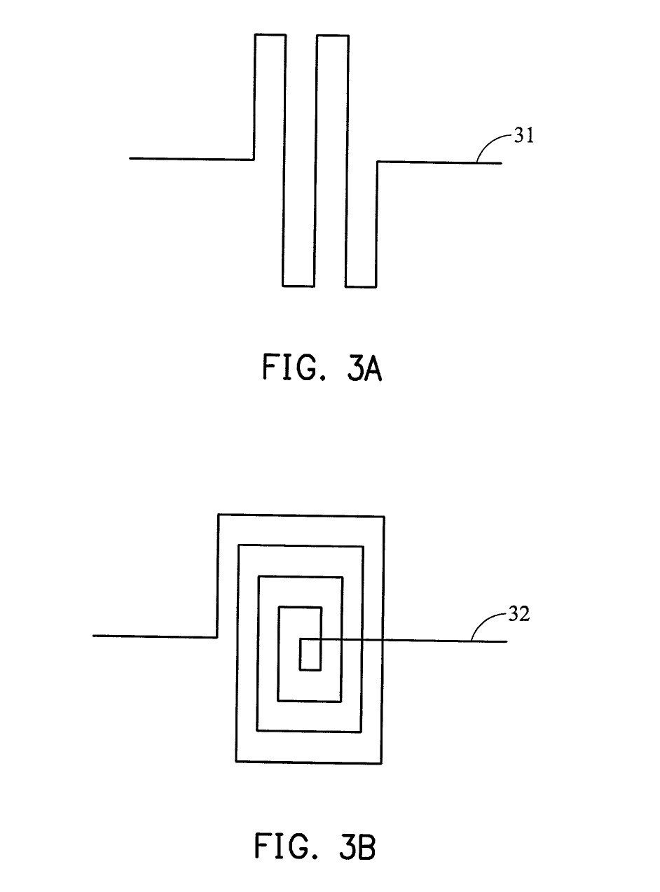

By comparing FIG. 2 with FIG. 1, it is noted that there is an additional inductor 19 in the ESD protection circuit shown in FIG. 2. The inductor 19 is a winding line 31 or 32 shown in FIG. 3A or FIG. 3B and generates an inductance between the pad 12 and the input terminal of the internal circuit 11. The magnitude of the inductance is properly selected so that the inductor 19 forms a conductive path from the pad 12 to the internal circuit 11 during normal operation of the internal circuit 11 and cuts off the conductive path when an ESD event occurs. Thus, the static charges flow through the diode 151b or transistor 162 but not the capacitor 18 to the VSS power supply. This eliminates the improper ESD path damaging the capacitor 18 or the internal circuit 11. For example, the magnitude of the inductance is selected as 10 nH when the frequency of the input signal is 4 MHz.

In conclusion, the present invention provides an ESD protection circuit protecting an internal circuit having a high capacitance at the input terminal. An inductor is connected between the pad and the input terminal of the internal circuit. Since the inductor cuts off the conductive path from the pad to the capacitor when an voltage pulse with a high frequency is induced on the pad by an ESD event, there is no longer an ESD current flow through the capacitor, which prevents damage to the capacitor and internal circuit.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An ESD protection circuit protecting an internal circuit powered by a first and second power supply and having an input terminal receiving an input signal on a pad, wherein a capacitor is connected between the input terminal of the internal circuit and the second power supply, the ESD protection circuit comprising:
a protection circuit connected between the pad and the first power supply, and establishing a conductive path from the pad to the first power supply when an ESD event occurs; and
an inductor connected between the pad and the input terminal of the internal circuit, and cutting off a conductive path from the pad to the capacitor when the ESD event occurs.

2. The ESD protection circuit as claimed in claim 1 wherein electrical charges flow from the pad to the first power supply through the conductive path established by the protection circuit when the ESD event occurs.

3. The ESD protection circuit as claimed in claim 1 wherein the first and second power supply provide a positive voltage VDD and negative voltage VSS to the internal circuit respectively.

4. The ESD protection circuit as claimed in claim 1 wherein the protection circuit comprises a transistor having a source and gate connected together.

5. The ESD protection circuit as claimed in claim 1 wherein the protection circuit comprises a diode.
